(19) United States
(12) Patent Application Publication
(10) Pub. No.: US 2011/0102146 A1
(43) Pub. Date: May 5, 2011

(54) SYSTEM AND METHOD FOR WIRELESSLY PAIRING AND ENABLING THE RECIPROCAL LOCATING OF KEYS AND HANDHELD COMMUNICATION DEVICES

(76) Inventor: Stephen J. Giron, Santa Fe, NM (US)

(21) Appl. No.: 12/612,282

(22) Filed: Nov. 4, 2009

(51) Int. Cl. H04Q 1/30; G08B 5/22

(52) U.S. Cl. 340/7.62; 340/7.2

(57) ABSTRACT

A system locating portable devices includes a fob wirelessly matched to a handheld device. The fob includes a transmitter, receiver, controller and memory storing codes/signals matching signals stored at a handheld device. The codes/signals supporting bi-directional communications between the fob and handheld device. The fob and handheld device can discover locations of each other by sending radio frequency signals from memory that are recognizable by each other. Matching and reciprocal discovery of device locations can be supported by Bluetooth communications.

### TECHNICAL FIELD

Embodiments are generally related to systems and methods for enabling wireless locating of devices. More particularly, the present invention is related to the wireless pairing of and wireless location of keys and handheld communication devices, such as cell phones. The present invention is also related to a system for locating lost keys and/or handheld devices that can use wireless communications.

### BACKGROUND OF THE INVENTION

Handheld communications devices such as cellular phones, personal digital assistants (PDAs) and keys to operate motor vehicles or open buildings are typically carried by people on the go. Oftentimes, keys or handheld devices will become misplaced as a result of a person moving about from location to location or within locations. Unfortunately, much time can become lost looking around for lost keys and handheld devices.

What is therefore needed is a system that can enable a person to quickly locate lost keys and handheld devices. The present inventor provides a solution to the stated problem by herein providing the description of a system and method that can wirelessly pair keys and handheld communication devices and also enable the reciprocal location of keys and handheld communication devices wirelessly once paired when a user is in possession of at least one of the paired devices.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the present invention to provide a system that can enable the wireless pairing and then reciprocal locating of keys and handheld devices that become separated from each other.

It is another aspect of the present invention to provide a system enabling the wireless pairing and then reciprocal locating of keys and handheld devices that become separated from each other using wireless communications (e.g., Bluetooth, RFID tags, and cellular communications networks).

It is yet another aspect of the present invention to provide a system enabling the wireless pairing and then reciprocal locating of keys and handheld devices that become separated from each other using wireless communications (e.g., Bluetooth, RFID tags, and cellular communications networks) and further using a key fob that can be provided to support bidirectional communications with a handheld device to enable each to determine the location and direction of the other using sound.

The aforementioned aspects and other objectives and advantages can now be achieved as described herein. The present invention can include a wireless fob that can be placed on a keychain and can become associated via wireless communications with a handheld device. The key fob can operate similarly to a remote control by transmitting a unique signal to a receiver associated with the paired handheld device. Similarly, the handheld device can transmit a unique signal that is recognized by the key fob. The process of locating devices is, therefore, reciprocal. Wireless pairing of the key fob and handheld device can be accomplished using Bluetooth communications.

It can also be appreciated that other wireless communications means can be utilized to accomplish bi-directional communication between the key fob and handheld device, such as radio frequency identification (RFID), RFID tagging technology and cellular technology. A software application module installed in the handheld device (e.g., Bluetooth pairing module currently installed in most smart phones) can enable pairing of the key fob with the handheld device. The key fob can include at least one button that can cause the transmitter to send its RF signal to a receiver in the handheld device. The key fob can also include a speaker for indentifying its location when a signal is sent from the handheld device. Similarly, the handheld device can provide an audio signal, such as a unique ring, when it is being paged by the key fob. Optionally, Silent or vibration modes in the handheld device can be programmed to be overridden when being paged by the fob.

The key fob as a remote control transmitter can be matched with the handheld device using procedures commonly used where Bluetooth is selected as the means for bi-directional communications. Matching procedures program the devices to recognize a unique wireless signal/code transmitted from a transmitter associated with the transmitting device. After matching the transmitter with the receiver, the unique code/signal on the transmitter can only be transmitted from the transmitter when the proper combination of key entries is entered on the handheld device or a button is pressed on the key fob or handheld device.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 illustrates a block diagram of a wireless fob and a handheld device matched for bi-directional wireless communication with each other, in accordance with an embodiment of the invention;

FIG. 2 illustrates a block diagram of circuit modules for a wireless fob that can be matched for bi-directional wireless communication with a handheld device, in accordance with an embodiment of the invention;

FIG. 3 illustrates a block diagram of circuit modules in a handheld device that can be matched for bi-directional wireless communication with a wireless fob, in accordance with an embodiment of the invention;

FIG. 4 illustrates a high-level flow chart of logical operational steps of a method for matching a fob with a handheld device and supporting bi-directional communication between the fob and handheld device for discovery of one from the other, in accordance with a preferred embodiment.

### DETAILED DESCRIPTION

The particular values and configurations discussed in these non-limiting examples can be varied and are cited merely to illustrate at least one embodiment and are not intended to limit the scope thereof.

Hand held transmitters such as remote controls are used to operate garage doors, gates and the like, typically utilize which emit encoded signals are transmitted at radio frequencies to a receiver associated with an automatic door or gate operator. The receiver is effective to intercept and decode the transmitted signal and thus cause the actuation of the operator to open or close the door or gate. These systems include the type in which the receiver has code switches which can be manually set to correspond to the authorized transmitter codes or, alternatively, may be “learn” type systems in which codes or the like used to identify authorized transmitter codes are initially stored in the receiver during a preparatory program or learn mode.

Remote control garage door or entry door openers presently available remain straightforward in operation and architecture. A portable RF transmitter (Radio frequency transmitter) is coded to open or matched with an opener associated with a secure entry (e.g., garage doors and gates). The RF transmitter is typically handheld, wireless and sends a RF signal that is matched with or learned by the entry receiver. For example, a transmitter in the form of a portable garage door opener typically kept in an automobile is matched by a unique RF signal generated by the transmitter to a receiver associated with the garage door opener equipment. A single button can be pressed on the transmitter to open or close a garage door or gate by transmission of a coded signage or unique frequency.

Wireless handheld devices, such as cellular phones, currently include Bluetooth technology, which enables the handheld device to be matched with other wireless devices including Bluetooth communications technology. Matching mostly occurs between handheld devices and combination earphone/speaker to enable hands free communications of a user while engaging in a physical activity requiring both of the user's hands, such as driving a car.

The present invention enables the matching of handheld devices, such as cellular phones, personal digital assistance, smart phones, which are carried by user for personal communications and productivity, with a wireless fob, which can be placed on a keychain to enable a user to locate keys attached to the fob or, alternatively, to enable a user to locate the handheld device using the fob. Although the fob is described as being used in association with keys, or a keychain, it should be appreciated that the fob can be attached to other items carried by user that are prone to becoming lost (e.g., bags, backpacks, etc.).

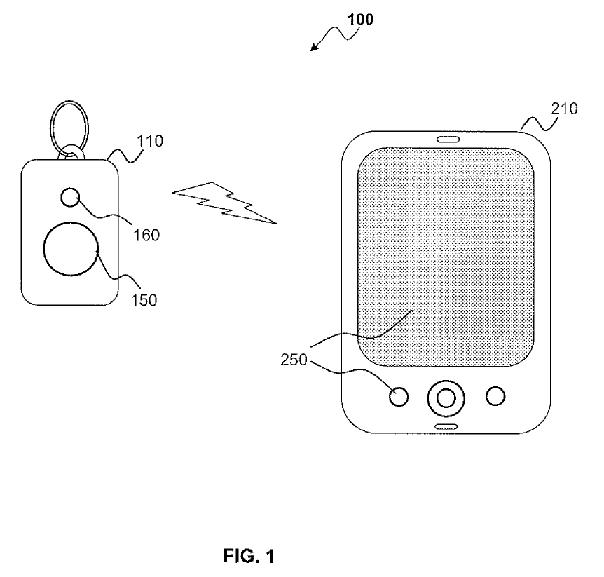

FIG. 1 illustrates a block diagram of a wireless fob 110 and a handheld device 210 matched for bi-directional wireless communication with each other, in accordance with an embodiment of the invention. The fob 110 operates as a portable, wireless transmitter and receiver that can be matched for bi-directional communications to a wireless handheld device 210 and can enable a user to use the fob to locate the handheld device 210, or to use the handheld device 210 to locate the fob 110. The fob can include at least one button 150 that can be pressed to cause an audio alarm to sound at the handheld device 210. A user interface 250 (e.g., buttons or touch screen) on the handheld device 210 can be used to send a wireless signal to the fob, causing the fob to create an audible alarm. The fob 110 and also optionally include a light 160 to provide a visual indication of its location. Similarly, the handheld device can provide a visual indication (e.g., the touchscreen can light up) when it receives a signal from the fob. If the handheld device is in silent or vibrate mode of operation, it can be optionally programmed to be override silent and vibrate modes of operation when a wireless signal is received from the paired fob.

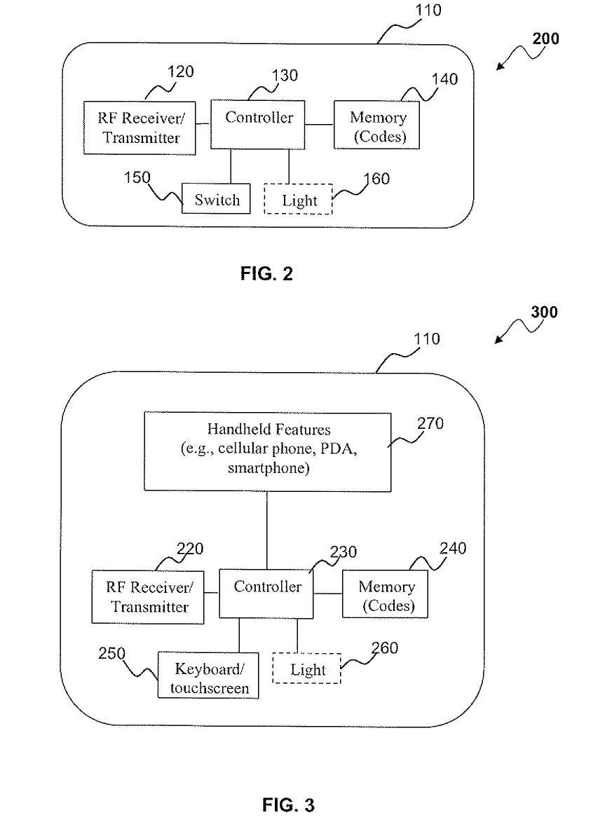

FIG. 2 illustrates a block diagram 200 of a wireless fob 110, which can be adapted for use in implementing a preferred embodiment. The fob 110 includes a radio frequency receiver/transmitter module 120 that can be provided for enabling bi-directional communications with a handheld device 210. A memory 140 can store codes or unique signals that enable communication with a handheld device 210. A controller 130 enables the fob to send and receive signals. Signals can be sent from the fob 110 using switch 150, which can be associated with a button on the fob. Light 160 can be optionally provided to enable the visual location of the fob when it receives a location signal from handheld device 210.

FIG. 3 illustrates a block diagram 300 of a wireless handheld device 210, which can be adapted for use in implementing a preferred embodiment. Wireless handheld devices are currently provided in many formats, such as cellular phones, smartphones, and personal digital assistants. Wireless handheld device are commonly used and enable voice and data communications for it users. Handheld devices also provide entertainment to its users. Handheld devices, like keys, can often become misplaced. Handheld device 210 is shown in FIG. 3 to also include a radio frequency receiver/transmitter module 220, a controller 230, and memory 240. Additionally, the handheld device 210 can include a user interface 250, which can be provided in the form of buttons or a touchscreen, which are typically found on wireless communications devices. An optional light 260 is also shown in the block diagram 300; however, it can be appreciated that current handheld devices can provide illumination with existing lights or visual displays. The handheld device can also include modules, including hardware and software, which enable handheld features 270 typically found in current wireless handheld communications devices.

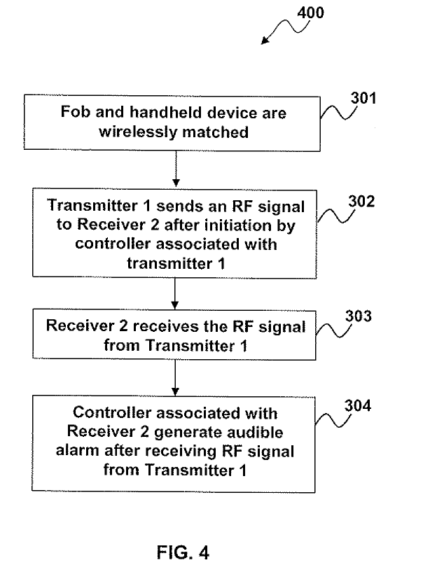

FIG. 4 illustrates a high-level flow chart 400 of logical operational steps for a method, which can be implemented in accordance with a preferred embodiment. As depicted at block 301, a fob and handheld device can be wirelessly matched. Wireless matching can be accomplished using Bluetooth discovery procedures commonly provided on modern cellular devices. Then as illustrated at block 202, transmitter 1 can send an RF signal to receiver 2. Transmitter 1 can be associated with either the fob or handheld device, while receiver 2 can then be associated with the opposite device (either the fob or handheld device, depending on which device originated the discovery signal). As shown in Block 303, receiver 2 (fob or handheld) receives the RF signal from transmitter 1 (handheld or fob). Finally, the controller associated with receiver 2 generates an audible signal after receiving the RF signal from transmitter 1.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A system for reciprocal locating of wirelessly paired electronic devices, comprising a fob including a transmitter, receiver, controller and memory that is wirelessly matchable to a handheld device including a transmitter, receiver, controller and memory, wherein memory in the fob and handheld device stores unique signals or codes supporting bi-directional communications between the fob and handheld device and wherein the fob and handheld device can discover locations of each other by sending a radio frequency signal from memory that is recognizable by each of the fob and handheld device.

2. The system of claim 1, wherein the fob and handheld device communicate using Bluetooth wireless communications.

3. The system of claim 1 wherein the fob is attached to a keychain and the handheld device includes at least one of a cellular phone, PDA or smartphone.

4. The system of claim 2 wherein the fob is attached to a keychain and the handheld device includes at least one of a cellular phone, PDA or smartphone.

5. The system of claim 3, wherein the fob and handheld device communicate using Bluetooth wireless communications.

6. A system for locating portable devices, comprising:
a fob including a memory storing a frequency code matched to a remote handheld device, a transmitter and receiver for communicating with the remote handheld device, controller managing communication with the remote handheld device, and a speaker providing an audible signal when the fob receives a signal from the remote handheld device.

7. The system of claim 6, wherein the fob is wirelessly matchable to a remote handheld device with unique signals or codes stored in the fob and the remote handheld device supporting bi-directional communications between the fob and handheld device.

8. The system of claim 6, wherein the fob and remote handheld device can discover locations of each other by sending a radio frequency signal from memory that is recognizable by each of the fob and handheld device.

9. The system of claim 6, wherein said fob and remote handheld device communicate using Bluetooth wireless communications.

10. A method for discovering the location of a lost fob or handheld device using a fob or handheld device that is not lost, the method comprising:
wirelessly matching a fob and handheld device using radio frequencies;
sending an RF signal from transmitter 1 to receiver 2;
receiving the RF signal with receiver 2;
generating an audible signal by a controller associated with receiver 2 after it receives the RF signal.

11. The method of claim 10, wherein said step of wirelessly matching the fob and the handheld device includes the use of Bluetooth discovery.
